(19) United States
(12) Patent Application Publication
(10) Pub. No.: US 2005/0247908 A1
(43) Pub. Date: Nov. 10, 2005

(54) Curing agents for epoxy resins, use thereof and epoxy resin cured therewith

(76) Inventors: Holger Keller, Sindelfingen-Darmsheim (DE); Udo Glauner, Sindelfingen (DE)

Correspondence Address: Norman P Soloway;Hayes Soloway, 130 West Cushing Street, Tucson, AZ, 85701, US

(21) Appl. No.: 10/526,539

(22) PCT Filed: Sep. 10, 2003
(86) PCT No.: PCT/EP03/10067

§ 371 Date: Mar. 3, 2005

(30) Foreign Application Priority Data
Sep. 11, 2002 (DE) 102 42 017.3

(51) Int. Cl. C09K 3/00

(52) U.S. Cl. 252/182.13

(57) ABSTRACT

Curing agents for epoxy resins are obtained by A) an addition of at least one aldehyde or ketone to at least one phosphonous acid derivative, followed by B) a condensation reaction of the adduct obtained with at least one diamino or polyamino compound. The resulting curing agents can be used alone or as co-curing agents for epoxy resins, and simultaneously as fire-retardants. Using the curing agents of the invention it is possible to prepare cured epoxy resins modified to be fire retardant which have a phosphorus content of at least 2.2% by weight without lowering the glass transition temperature (T_{g}) to below 150° C. Use of the curing agents and epoxy resins produceable therewith are other objects of the present invention.

The invention relates to new, phosphorus-containing curing agents for epoxy resins which at the same time provide fire-inhibiting effects.

Commercially available epoxy resins are usually liquid, viscose, glassy or also crystalline substances which before being used are mixed with adequate curing agents and optionally also modified with solvents, reactive diluents (viscosity lowering epoxy resins), softeners, fillers, or pigments. As curing agents are used, for example, dicarboxylic acid anhydrides or amine curing agents such as diethylene triamine. There are systems of epoxy resins and curing agents which at room temperature cure immediately after the epoxy resin and curing agent are brought together, and there are systems which cure only after a certain “working time” after the epoxy resin and curing agent have been brought together, or only after a relatively high temperature has been exceeded. Since in the last mentioned systems the curing effect first occurs following a certain delay, the curing agents used therefor are occasionally designated as “latent curing agents.”

The process of making epoxy resins fire retardant, as prescribed for many applications, previously was carried out by incorporating traditional flame-protection agents such as antimony trioxide or highly brominated organic compounds into the epoxy resin compositions. (See, for example, “International Plastics Flammability Handbook” 2nd edition, Carl Hanser Publishing House, Munich, 1990). Aside from the toxicological risks, the use of such traditional flame-protection agents often led to impairment of the mechanical and physical properties of the epoxy resins incorporating such agents therein. Therefore, it previously has been proposed to use reactive flame-protection agents which are bonded to the polymer structure of the epoxy resin such as, for example 10-Oxo-10H-9-oxa-10-phospha-phenanthrene known as “SOP” which can also be designated as 9,10-Dihydro-9-oxa-10-phospha-phenanthrene-10-oxide (see EP-B1-0 806 429, Claim 24).

In a trifunctional epoxy-Novolac resin, DOP reacts with the glycidyl groups of the resin according to the following reaction diagram:

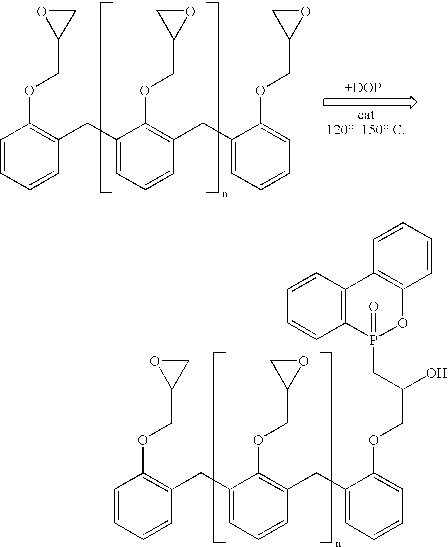

However, the above-described process for making the epoxy resins fire retardant with DOP is insufficient for many applications for the following reasons:
For standard fire-protection modifying of epoxy resins there is required a phosphorus content of more than 2.2% by weight based on the total mass of the modified and cured epoxy resin. To attain such phosphorus content the portion of DOP had to comprise at least 60% of the modified resin.
Such a high portion of fire-protection agent results in a reduction of the glass transition temperature (T_{g}). Depending on the epoxy resin, there can thus be used only glass transition temperatures of less than 150° C., dynamically measured by Dynamic Scanning Calometry (“DSC”). A T_{g} typical for such systems is 135° C. (DSC). But epoxy resins to be used for preparing printed circuit board substrates or for other electronic purposes such as casting resins or embedding masses must have, with regard to the lead-free tin solder compositions in use at present, having melting points between about 185 and 205° C., a glass transition temperature of at least 150° C., preferably more than 160 or 165° C. (DSC).
DOP can only be used for a few epoxy resins as fire-protection agent directly bonding to the glycidyl groups. However, in case of a slight change of the chemical structure of the resin, for example, changing from phenol-Novolac resin to cresol-Novolac, incompatibility problems can appear.

DE-OS 100 06 592 discloses “latent” combination compounds consisting of amine curing agents for epoxy resins and fire-protection agents as, for example, DOP, the same as the use thereof for preparing cured, fire-retardant modified epoxy resins which, when present as one-component system, exhibit a working time of several hours during which no curing occurs, or which cure only when a certain relatively high threshold temperature is exceeded. In these known latent curing agents the nitrogen atom of the amino groups of an amine curing agent is directly bonded to the phosphorus atom of DOP.

The problem which the present invention addresses is to provide novel curing agents for epoxy resins which simultaneously exhibit curing and flame-inhibiting characteristics, which either alone or as co-curing agents have a phosphorus content required for the desired fire-protection of at least 2.2% by weight of the cured epoxy resin without lowering the glass transition temperature T_{g} of the resin to a value below 150° C. (DSC).

According to the invention this problem is solved by a curing agent for epoxy resins that can be obtained by the steps of:
(A) An addition of at least one aldehyde or ketone of the formula I: 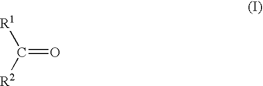
   wherein R¹ and R² independently of each other are selected from a hydrogen atom, an optionally substituted C₁-C₈-alkyl, aryl, alkaryl, or aralkyl group, to at least one phosphonous acid derivative of the formula II: 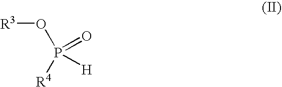
   wherein R³ and R⁴ independently of each other are selected from an optionally substituted C₁-C₈-alkyl, cycloalkyl, aryl, alkaryl, aralkyl, or heteroaryl group, or R³ and R⁴ together are selected from a mononuclear or polynuclear, optionally substituted, aromatic or non-aromatic ring system (first step) and
(B) a condensation reaction of the adduct obtained in the first step with at least one diamino or polyamino compound (second step).

It surprisingly has been found that when using the curing agent of the present invention for curing and making fire-retarding epoxy resins, the required phosphorus content for standard flame-protection modification of at least 2.2% by weight can be reached without harmful reduction of the glass transition temperature of the resin to below 150° C. There was on the contrary found an increase of the glass transition temperature to up to 170° C. (DSC) with a phosphorus content of the resin of about 3% by weight. Thereby can be satisfied the need of halogen-free, fire-retardant and cured epoxy resin systems which can be used particularly for the preparation of printed circuit board substrates and other electronic parts which come into contact with lead-free solder tin of high melting point.

For the curing agents of the present invention, the aldehydes preferably comprise formaldehyde, paraformaldehyde, a formaldehyde rendering compound such as 1,3,5-trioxane or an optionally substituted benzaldehyde while as ketones can preferably be used an optionally substituted acetophenone or benzophenone.

As diamino or polyamino compounds preferably ethylene diamine, 4,4′-diamino-diphenyl methane, 4,4′-diamino-diphenyl sulphone (DDS), urea, or melamine can be used.

The addition reaction in the first step of preparation of the curing agents of the present invention can preferably be carried out at a temperature of from 50 to 150° C., while the condensation reaction in the second step can be carried out preferably at a temperature of from 100 to 200° C., optionally in the presence of a catalyst.

For the preparation of the curing agent of the present invention, as phosphonous acid derivative there is preferably used the compound 10-Oxo-10H-9-oxa-10-phospha-phenanthrene (equivalent to 9,10-Dihydro-9-oxa-10-phosphaphenanthrene-10-oxide) known as “DOP” or a mixture containing DOP and 2′-hydroxydiphenyl-2-phosphinic acid, as known, for example from EP-B1-0833832.

In the preparation of the curing agent of the present invention, the molar ratio of the components (a) aldehyde or ketone, (b) phosphonous acid derivative and (c) diamino or polyamino compound is preferably from a:b:c=1:1:1 to a:b:c=x:x:1 wherein x corresponds to the number of amino groups in one molecule of the polyamino compound.

Preferred embodiments of the inventive curing agent are characterized by a molecular structure containing at least one radical of the formulae III, IV, V or VI:

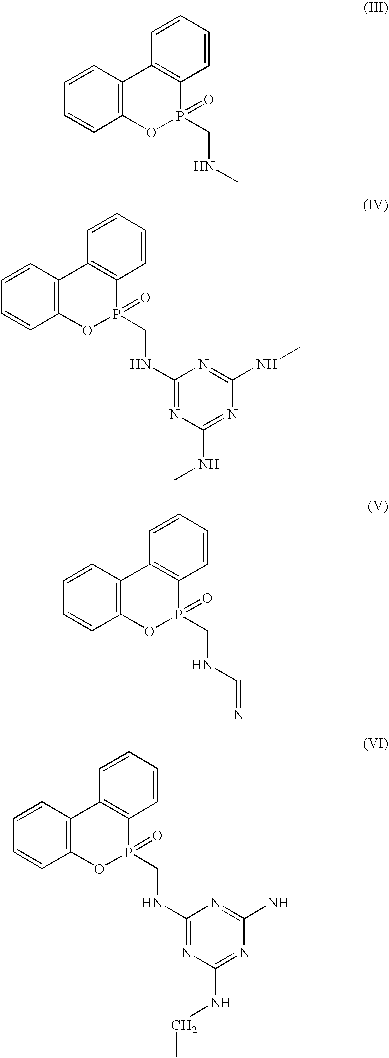

One specially preferred curing agent of the present invention is N,N′,N″-Tris-(10-oxo-10H-9-oxa-10-phospha-phenanthrene-10-ylmethyl)-[1,3,5]triazine-2,4, 6-triamine which has the structural formula VII:

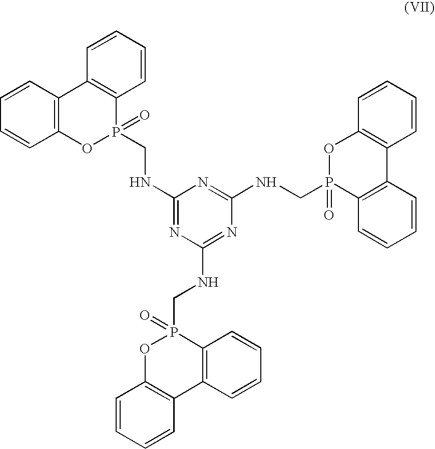

The curing agents of the present invention can be used as a single curing agent or as co-curing agent for epoxy resins, which means together with at least one other curing agent for epoxy resins, preferably together with an amine curing agent, specially one or more of the group consisting of diethylene triamine, dimethyl amino propylamine, isophoron-diamine, dicyan diamide (cyanoguanidine).

Specially advantageous is the use of the curing agent of the present invention for raising the glass transition temperature of the cured epoxy resin to above 150° C., particularly to above 165° C. (DSC in each case).

Likewise particularly advantageous is the use of the curing agent of the present invention for flameproofing an epoxy resin, preferably preferred for preparing cured epoxy resins modified to be fire retardant and having a phosphorus content of at least 2.2% by weight, preferably of 2.8 to 3.2% by weight.

Another object of the present invention is constituted by epoxy resins cured and modified to be fire retardant with a curing agent of the present invention, said epoxy resins being preferably epoxy-Novolac resins.

The epoxy resin cured and modified to be fire retardant according to the present invention serves preferably for making printed circuit board substrates and other products in the field of microelectronics in which, due to the contact with molten lead-free tin solder usually having a melting point between about 185 and 205° C., a high glass transition temperature of at least 150° C. (DSC) and at the same time an effective flame protection are especially important.

The invention is explained in detail herebelow with reference to the following working example:

### EXAMPLE

Preparation of the Curing Agent

A) First Step

40 g (185 mmol) DOP were heated to 130° C., 15 g formaline solution (37% by weight) were added drop by drop at this temperature over 45 minutes while stirring. After another 30 minutes a white solid body formed which began to melt at about 140° C.

B) Second Step

The adduct generated in the first step was further heated to about 150° C. To the resulting clear solution were added 7.8 g melamine (61.7 mmol) and the mixture was heated over two hours to 200° C. The mixture was kept at 200° C. until no more water was formed.

Curing and Flameproofing an Epoxy Resin

7 g of an epoxy-Novolac resin (LER N 740 available from the firm LG, Korea; epoxide number: 0.575 mol/100 g) and 3g of an epoxy-Novolac resin (Ukanol EPUK available from the firm Schill+Seilacher, Boeblingen; epoxide number: 0.28 mole/100 g) were heated with 3 g of the curing agent of the present invention and prepared as above to 160° C. and stirred until a clear solution formed. Into this solution was incorporated 2.4 g diamino diphenyl sulphone in solid form and stirred until a clear solution formed. The solution was held for 15 minutes at 160° C., then 30 minutes at 175° C. and finally 3 hours at 195° C. and thereby cured. There resulted a yellow transparent solid body of cured epoxy resin simultaneously modified to be fire retardant. The glass transition temperature of the resin prepared was 170° C. (DSC) and had a phosphorus content of 2.9% by weight. The resulting cured sample satisfied the UL94 V-0 fire protection standard of Underwriters' Laboratories (USA).

1-26. (canceled)

27. A process for preparing a curing agent for epoxy resins comprising the steps of
A) the addition reaction of at least one aldehyde or ketone of the formula I: 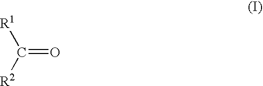
wherein R¹ and R² independently of each other are selected from a hydrogen atom, an optionally substituted C₁-C₈-alkyl, aryl, alkaryl, or aralkyl, and at least one phosphonous acid derivative of the formula II 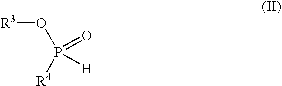
wherein R³ and R⁴ independently of each other are selected from an optionally substituted C₁-C₈-alkyl, cycloaklyl, aryl, alkaryl, aralkyl, heteroalkyl, or R³ and R⁴ together are selected from a mononuclear or polynuclear, optionally substituted, aromatic or non-aromatic ring system; and
B) a condensation reaction of the adduct obtained in step (A) with at least one diamino or polyamino compound.

28. The process according to claim 27, wherein the aldehyde comprises formaldehyde, paraformaldehyde, a formaldehyde rendering compound or an optionally substituted benzaldehyde.

29. The process according to claim 28, wherein the formaldehyde rendering compound comprises 1,3,5-trioxane.

30. The process according to claim 27, wherein the ketone comprises an optionally substituted acetophenone or benzophenone.

31. The process according to claim 27, wherein the addition reaction is carried out at a temperature of from 50 to 150° C.

32. The process according to claim 27, wherein the diamino or polyamino compound comprises ethylene diamine, 4,4′diamino-diphenyl methane, 4,4′-diamino-diphenyl sulphone (DDS), urea or melamine.

33. The process according to claim 27, wherein the condensation reaction is carried out at a temperature of from 100 to 200° C.

34. The process according to claim 27, wherein the condensation reaction is carried out in the presence of a catalyst.

35. The process according to claim 27, wherein phosphonous acid derivative is selected from 10-Oxo-10H-9-oxa-10-phospha-phenanthrene (9,10-Dihydro-9-oxa-10-phospha-phenanthrene-10-oxide) (“DOP”) or a mixture containing DOP and 2′-hydroxydiphenyl-2-phosphinic acid.

36. The process according to claim 27, wherein the components (a) aldehyde or ketone, (b) phosphonous acid derivative and (c) di amino or polyamino compound are reacted in a mole ratio of from a:b:c=1:1:1 to a:b:c=x:x:1, wherein x corresponds to the number of amino groups in one molecule of the polyamino compound.

37. A fire retardant curing agent for epoxy resins having a molecular structure containing at least one radical of the formula III:

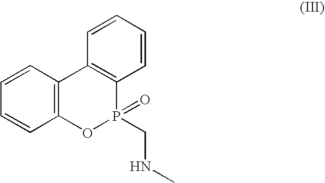

38. A fire retardant curing agent for epoxy resins having a molecular structure containing at least one radical of the formula IV:

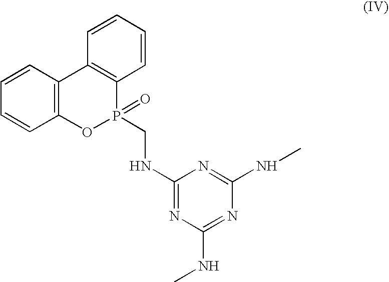

39. A fire retardant curing agent for epoxy resins having a molecular structure containing at least one radical of the formula V:

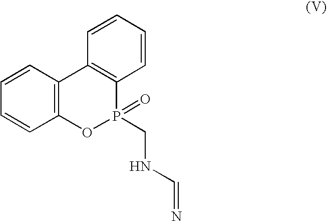

40. A fire retardant curing agent for epoxy resins having a molecular structure containing at least one radical of the formula VI:

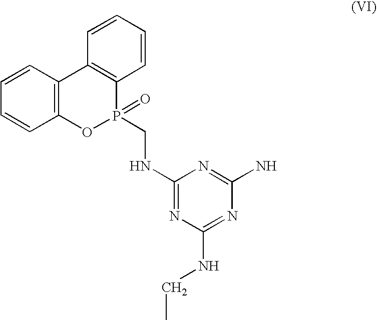

41. A fire retardant curing agent for epoxy resins having the formula: N,N′N″-Tris-(10-oxo-10H-9-oxa-10-phospha-phenanthrene-10-ylmethyl)-[1,3,5]triazine-2,4,6-triamine.

42. A process for preparing a fire resistant epoxy comprising curing the epoxy with a curing agent made by the process of claim 27.

43. The process according to claim 42, wherein the curing agent made by the process of claim 27 is used together with another conventional curing agent for epoxy resins.

44. The process according to claim 43, wherein the conventional curing agent comprises an amine curing agent.

45. The process according to claim 44, wherein the curing agent comprises diethylene triamine, dimethyl aminopropylamine, isophorondiamine or dicyan diamide (cyanoguanidine).

46. A cured epoxy made using a curing agent made by the process of claim 27.

47. A cured epoxy made as claimed in claim 46, having a glass transition temperature (T_{g}) of above 150° C. (DSC).

48. A cured epoxy as claimed in claim 46, having a glass transition temperature of above 165° C. (DSC).

49. A cured epoxy as claimed in claim 46, having a phosphorus content of at least 2.2% by weight.

50. A cured epoxy as claimed in claim 46, having a phosphorus content of from 2.8 to 3.2% by weight.

51. A cured epoxy as claimed in claim 46, comprising epoxy-Novolac resin.

52. A printed circuit board made from the epoxy resin as claimed in claim 46.
